(19) United States
(12) Patent Application Publication
(10) Pub. No.: US 2026/0172223 A1
(43) Pub. Date: Jun. 18, 2026

(54) SYSTEMS AND METHODS OF LAYERING SECURITY FOR CELLULAR-ENABLED BLOOD GLUCOSE DATA TRANSMISSION

(71) Applicant: Smart Meter, LLC, Tampa, FL (US)

(72) Inventor: Derek Trauger, Tampa, FL (US)

(73) Assignee: Smart Meter, LLC, Tampa, FL (US)

(21) Appl. No.: 19/425,497

(22) Filed: Dec. 18, 2025

Related U.S. Application Data
(60) Provisional application No. 63/735,521, filed on Dec. 18, 2024.

(51) Int. Cl. H04L 9/06; H04L 9/08; H04W 12/033

(52) U.S. Cl. CPC H04L 9/0618; H04L 9/0643; H04L 9/085; H04W 12/033

(57) ABSTRACT

The present disclosure is directed to a system for improving the security of cellular-enabled blood glucose data transmission by layering security, the system comprising: an apparatus; a wireless network; a private network connected via a persistent IPsec VPN tunnel; one or more computer processors; and a memory with instructions that cause the system to: collect initial blood glucose data from a patient; encrypt the data with a shared secret; generate a first hash using a signing algorithm; transmit the encrypted data via the IPsec VPN tunnel to the private network; generate a second hash; compare the first hash to the second hash; decrypt the encrypted data upon a match, creating verified blood glucose data; and transmit the verified data to a target recipient.

### FIELD OF THE PRESENT DISCLOSURE

The present disclosure is directed to a system, method and apparatus to be used for various types of medical tests in which an aggregate of test results is to be compiled, automatically transmitted, and monitored. In particular, the apparatus enables wireless transmission, storage, monitoring, notifications, and the like to keep individual users and third parties apprised of at least one medical test result.

### INTRODUCTION

It is estimated that diabetes care costs in excess of $218 billion in the U.S. The $218 billion amounts to about 10 percent of all U.S. health care spending by government and the public, about $2.1 trillion in 2006, and nearly half the $448.5 billion cost of heart disease and stroke. Diabetes mellitus, or diabetes as it is commonly known, includes several different metabolic disorders that result in high concentrations of glucose in the blood. It is currently estimated that diabetes care costs in excess of $240 billion in the U.S. every year alone. This $240 billion figure amounts to about 10% of all U.S. health care spending.

In order to help treat diabetes, a person may be prescribed diet changes, medications, insulin. However, a person must still be cognizant of their blood glucose levels to prevent a drop or spike in said levels which may lead to various ailments including, in severe cases, coma and death. Thus, diabetics should monitor their blood glucose levels with the aid of a glucose meter. Optimal measurement involves a patient measuring and recording their blood glucose levels over a period of time and in relation to certain events (i.e. eating and exercise). By understanding what effects food and exercise have on their blood glucose levels, appropriate lifestyle shifts can be made.

However, current blood glucose meters have several drawbacks. For example, blood glucose meters often lack the ability to communicate with another remote location such as a doctor's office. Thus, in order to a doctor to be kept apprised of a diabetic's situation, they have to assume the diabetic patient is testing themselves regularly and being truthful in their test results.

Thus, there is a need for a blood glucose meter that can automatically send test results to a remote location for instant analysis. This allows, for example, an alert or notification to be generated and sent to family members if a person's blood glucose level is such that it may signify that are in or about to be in danger of becoming hypoglycemic or hyperglycemic.

### SUMMARY

Aspects of the present disclosure may relate to a system for improving the security of cellular-enabled blood glucose data transmission by layering security. In an embodiment, the system may comprise an apparatus, a wireless network connected to the apparatus, a private network connected to the wireless network via a persistent and fully redundant Internet Protocol Security (IPsec) Virtual Private Network (VPN) tunnel, one or more computer processors, and a memory having stored therein machine executable instructions, that when executed by the one or more processors, cause the system to collect, via the apparatus, initial blood glucose data from a patient. Furthermore, the instructions may further cause the system to encrypt, via the apparatus, the initial blood glucose data with a shared secret, wherein encrypting the initial blood glucose data creates encrypted blood glucose data. In one embodiment, the instructions may further cause the system to generate, via the apparatus, a first hash using a signing algorithm. Moreover, the instructions may further cause the system to transmit, via the persistent and fully redundant IPsec VPN tunnel, the encrypted blood glucose data from the apparatus to the private network. Yet further, the instructions may further cause the system to generate, via the private network, a second hash. In another embodiment, the instructions may further cause the system to compare, via the one or more computer processors, the first hash to the second hash. In yet another embodiment, the instructions may further cause the system to decrypt, via the one or more computer processors, the encrypted blood glucose data upon a match of the first and second hash, wherein decrypting the encrypted blood glucose data creates verified blood glucose data. In an embodiment, the instructions may further cause the system to transmit, via the one or more computer processors, the verified blood glucose data to a target recipient.

According to other aspects of the present disclosure, the system may include one or more of the following features. The shared secret may be a symmetric-key algorithm comprising at least one key and a symmetric block cipher. The at least one key may be comprised of at least one of a 128-bit key, a 256-bit key, a 576-bit key, and a 2040-bit key. The symmetric block cipher may be comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. The persistent and fully redundant IPsec VPN tunnel may leverage the symmetric-key algorithm to encrypt the encrypted blood glucose data while said encrypted blood glucose data is travelling through the persistent and fully redundant IPsec VPN tunnel. The apparatus may connect to the wireless network via an Access Point Name (APN). The persistent and fully redundant IPsec VPN tunnel may be further comprised of Transport Layer Security (TLS). The verified blood glucose data may be transmitted to one or more apparatuses of the target recipient. The signing algorithm may be comprised of at least one of Rivest-Shamir-Adleman (RSA) algorithms, EIGamal signature scheme, Digital Signing Algorithm (DSA), and Elliptical Curve Digital Signature Algorithm (ECDSA).

According to another aspect of the present disclosure, a method for improving security of cellular-enabled blood glucose data transmission by layering security may be provided. The method may comprise collecting, via patient interaction with apparatus, raw blood glucose data from the patient. In an embodiment, the method may further comprise encrypting, via an encryption algorithm generated by the apparatus, the raw blood glucose data, creating encrypted blood glucose data. Moreover, the method may further comprise signing, via a signing algorithm, the encrypted blood glucose data creating a first hash. The method further comprises connecting, via an Access Point Name (APN), the apparatus to a wireless network. In a further embodiment, the method may further comprise connecting, via a persistent and fully redundant Internet Protocol Security (IPsec) Virtual Private Network (VPN) tunnel, the wireless network to a private network. Further, the method may comprise transmitting the encrypted blood glucose data from the apparatus to the private network, wherein, upon receipt of the encrypted blood glucose data, the private network generates a second hash. In yet a further embodiment, the method may further comprise verifying, via a comparison of the first hash and second hash, the encrypted blood glucose data, wherein upon a match of the first hash and the second hash, the private network decrypts the encrypted blood glucose data, creating verified blood glucose data. Yet further, the method may comprise transmitting the verified blood glucose data to a target recipient.

According to other aspects of the present disclosure, the method may include one or more of the following features. The encryption algorithm may comprise a shared secret. The shared secret may be a symmetric-key algorithm comprising a key and a symmetric block cipher. The key may be comprised of at least one of a 128-bit key, a 256-bit key, a 576-bit key, and a 2040-bit key. The symmetric block cipher may be comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. The persistent and fully redundant IPsec VPN tunnel may leverage the symmetric-key algorithm to encrypt the encrypted blood glucose data while travelling through the persistent and fully redundant IPsec VPN tunnel. The persistent and fully redundant IPsec VPN tunnel may be further comprised of Transport Layer Security (TLS). The signing algorithm may be comprised of at least one of Rivest-Shamir-Adleman (RSA) algorithms, EIGamal signature scheme, Digital Signing Algorithm (DSA), and Elliptical Curve Digital Signature Algorithm (ECDSA).

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 is an illustrative view of a display box of the present disclosure.

FIG. 2 is an illustrative view of a representative example of daily blood glucose readings of the present disclosure.

FIG. 3 is an illustrative view showing a logbook where the date and time period of a recorded blood glucose reading is displayed.

FIG. 4 is an illustrative view of a user's profile of the present disclosure.

FIG. 5 is an illustrative view of the Data Recipients screen of the present disclosure.

FIG. 6 is an illustrative view of the Alerts screen of the present disclosure.

FIG. 7 is an illustrative view of the Registration screen of the present disclosure.

FIG. 8 is a perspective view of an embodiment of the present disclosure.

FIG. 9 is a front view of an embodiment of the present disclosure.

FIG. 10 is a back view of an embodiment of the present disclosure.

FIG. 11 is a left side view of an embodiment of the present disclosure.

FIG. 12 is a right side view of an embodiment of the present disclosure.

FIG. 13 is a top view of an embodiment of the present disclosure.

FIG. 14 is a bottom view of an embodiment of the present disclosure.

FIG. 15 illustrates an embodiment of a system of layering security for cellular-enabled blood glucose data transmission.

FIG. 16 illustrates an embodiment of a method of layering security for cellular-enabled blood glucose data transmission.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

Having identified the problem/opportunity within this $218 billion market, we can now establish the necessity for a glucose meter that can share data and integrate with electronic medical records with extreme reliability. The system is designed with triple redundancy and extreme reliability. Every Glucose reading is life and death to a diabetic patient. Accordingly, health care and service providers need to be notified upon a moment's notice. Known in the art are glucometers which read blood glucose sample and require an additional step for the blood glucose result to be transmitted to a diabetic patient's primary care physician. The present system eliminates this additional step and allows for a blood glucose reading to automatically and instantaneously delivered to a plurality of designated individuals at a desired frequency and through multiple communication methods, each of which are built into the device and supporting software systems. The system supports 3 communication methods SMS, GPRS and USSD as explained below.

The system and device transmits, receives and delivers blood glucose readings and messages through Unstructured Supplementary Service Data (hereinafter USSD), a protocol according to the GSM standard. [The GSM was developed by the European Telecommunications Standards Institute (ETSI) to describe protocols for digital cellular networks used by mobile phones to communicate with a service provider's computers.] USSD is used for wireless application protocol browsing, prepaid callback service, mobile-money services, location-based content services, menu-based information services, and as part of configuring a phone on a network. USSD messages are up to 182 alphanumeric characters in length. USSD messages create a real-time connection and remains open, allowing a two-way exchange of a sequence of data.

The system and device transmits, receives and delivers blood glucose readings and messages through Greedy Perimeter Stateless Routing (GPSR). GPSR, is an efficient routing protocol for mobile, wireless networks. GPSR is a geo routing method wherein data packages are not sent to a special receiver but to network coordinates according to a greedy algorithm (i.e. a network coordinate that is local, and the optimally closer to the destination). Data packages are relayed to a node that's geographically closest to the coordinates.

The system and device transmits, receives and delivers blood glucose readings and messages through Short Message Service (hereinafter SMS). SMS is a text messaging service component of phone, Web, or mobile communication systems. It uses standardized communications protocols to allow fixed line or mobile phone devices to exchange short text messages.

The system and device utilizes the ACCU-CHEK Inform II system which offers healthcare professionals the first truly wireless hospital blood glucose device. The system utilizes technology to deliver improved accuracy and enables automatic real-time wireless transfer of patient data between hospital medical staff and the laboratory. The system and device utilizes a mobile approach to diabetes education and support. The system enables a patient's profile to be personalized in order to help people with type 2 diabetes take better control of their condition. The software based program, entitled Care2Life focuses on education and adherence to the participant's treatment protocol. It also allows participants to build an electronic record of blood glucose readings, blood pressure, weight and exercise that they can view on-line and share with their providers.

Current attempts, devices, systems and methods known in the art are deficient. Traditionally and unbelievably, most methods, devices and software platforms capture data from their diabetic patients manually. The present disclosure, referred to as The Smart Glucose Meter (or SGM) can easily be integrated in a meaningful way with electronic medical record (hereinafter EMR) companies. The Smart Glucose Meter is a glucose meter that not only can share data but does so easily, seamlessly and technologically advanced, automatically integrating with electronic medical records.

There are more than two dozen studies that depict results requiring capture of diabetes data to manage this disease. Yet to date, there exist but one device owned by Telcare, Inc. that has developed an automatic method to capture this data. However, the Telcare device does not share data with other Electronic Medical Record platforms or systems. The present system and device is an Open Application interface and data can be pushed and pulled from a variety of electronic medical record software's, programs, and systems.

Various other systems and methods are known in the art as described above. However, their structure and means of operation are substantially different from the present disclosure. The other disclosures fail to solve all the problems taught by the present disclosure. At least one embodiment of this disclosure is presented in the drawings below and will be described in more detail herein.

The preferred embodiments of the present disclosure will now be described with reference to the drawings. Identical elements in the various figures are identified with the same reference numerals.

Reference will now be made in detail to each embodiment of the present disclosure. Such embodiments are provided by way of explanation of the present disclosure, which is not intended to be limited thereto. In fact, those of ordinary skill in the art may appreciate upon reading the present specification and viewing the present drawings that various modifications and variations can be made thereto.

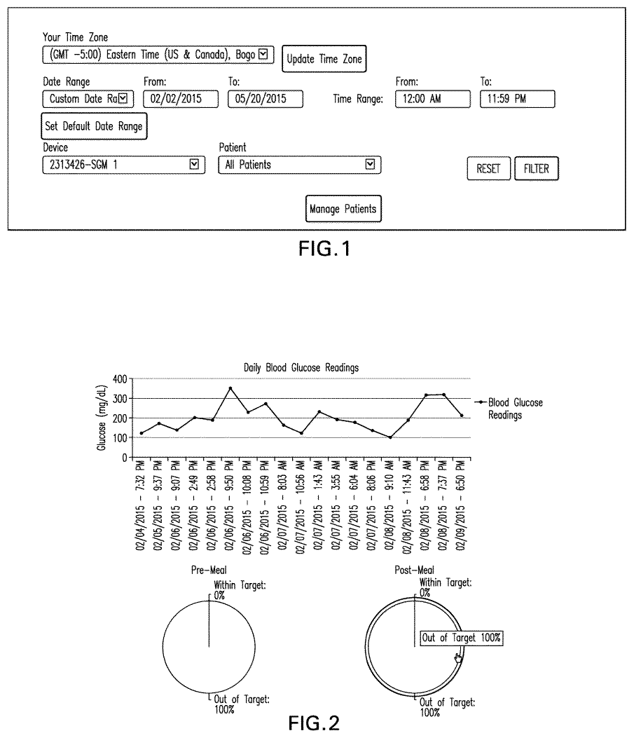

The system, methods and device of the present disclosure utilize a software based system and device which contain the following screens and displays and are meant to be illustrative and representative. FIG. 1 is a perspective view of a display box of the present disclosure displaying a user may set the date range and so that medical test data will appear. A user may set the time zone where the user is located, or the device may automatically recognize the time zone where the user and device is located. The user may select a time range as well as set these ranges to a default setting. The system and device allows for the storing of multiple users. Thus, a user of the device may select what user's records or data they want to view. The device may store up to 35 users or patients. Each user or patient is assigned an identification number such as P1 or P35. In another embodiment of the disclosure, the user may select for other fields to be displayed.

FIG. 2 is an illustrative example of daily blood glucose readings of the present disclosure. The above graph shows tracks the blood glucose readings or scores which are recorded over a specified range of dates and times. For example, on Feb. 4, 2015, at 7:32 pm the blood glucose score was slightly above 100 Milligrams per Deciliter (mg/dL) while on Feb. 8, 2015, at 6:58p.m. the user's blood glucose score was slightly over 300 mg/dL. In the pie charts below, the average reading is shown as being within the target range of a normal blood glucose level before a meal (pre-meal) and whether the reading was within the target range of a normal blood glucose reading after a meal (post meal). A user may set a range of where they desire their score to be, and the pie chart can determine if a user's blood glucose readings are within that desired range. In another embodiment, the graphs may be pie charts, bar graphs or color graphs. The graphs may only display information from a particular day, time period or blood glucose reading. Time may be recorded in hour, minutes and seconds. In another embodiment, the user may select the type of graph they desire and the desired medical test data they want displayed. A user may select the time format and date format of his choosing. Additional data to be recorded include temperature in Fahrenheit or Celsius,

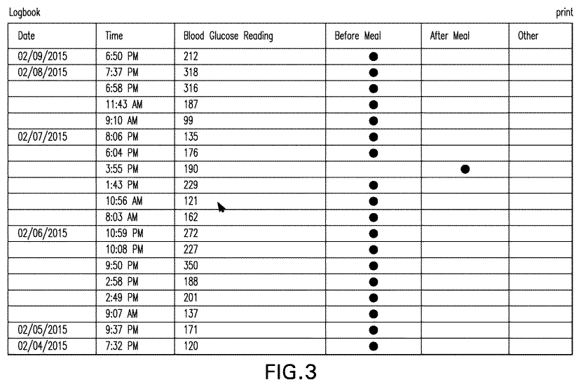

FIG. 3 is an illustrative view showing a logbook where the date and time period of a recorded blood glucose reading is displayed. A user's average blood glucose readings (as recorded from a test strip) are displayed in chart formation showing the date, time, blood glucose reading, and whether the reading was before or after a meal. The logbook may be printed or emailed to a designated individual. In another embodiment the logbook may be in different display forms. In another embodiment a user may select other data to be displayed. In another embodiment the data or portions of the data can be extracted and sent to a designated individual such as a medical service provider. A user's average blood glucose readings are saved in the device for a specified period of time and are further stored in the systems software as well as in the cloud storage unit of each user and health care provider of each

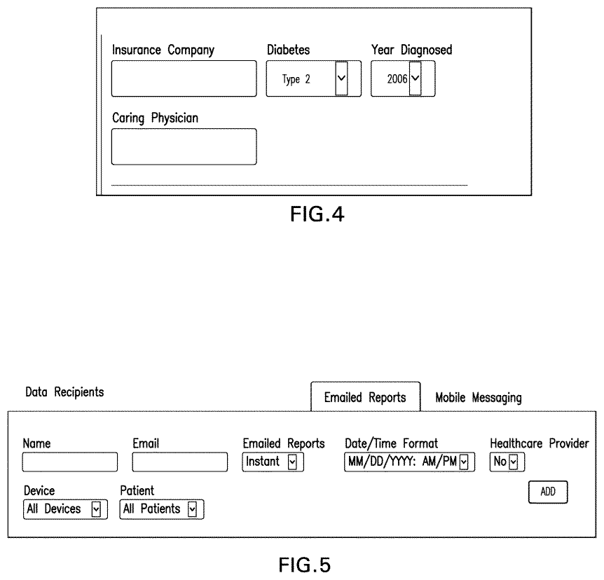

The system, device and corresponding software allow a user to create a profile. FIG. 4 is an illustrative view of a user's profile of the present disclosure. In addition to a user entering his personal and medical information, a user is able to enter his insurance information, diabetes type, year of diagnosis and treating doctor. In another embodiment a user may enter all physicians who are treating each specified user.

FIG. 5 is an illustrative view of the Data Recipients screen of the present disclosure. The user of the system or device may choose their intended recipient of medical test data and whether the recipient received the data via an email or text, the frequency of those messages, the date and time the message or transmission is to be sent, and whether the recipient is a healthcare professional. A user may display a listing of all emailed reports sent to a particular recipient. The system is able to send messages and data from multiple devices of multiple users to multiple recipients.

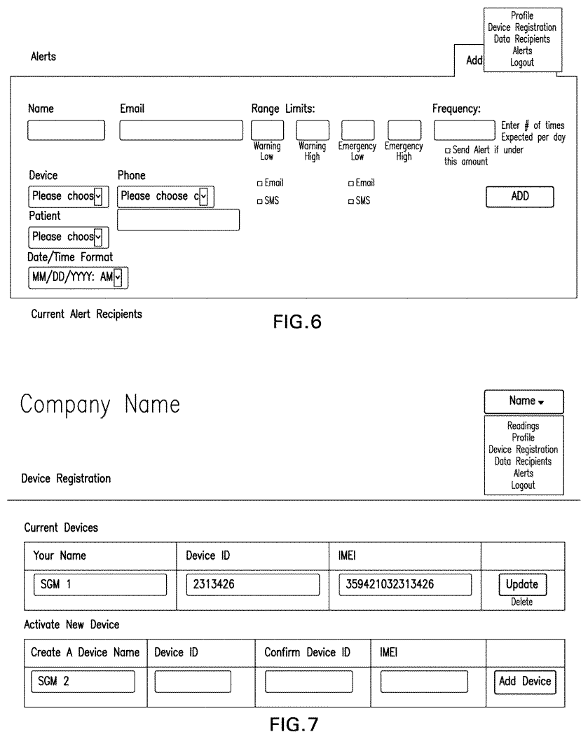

FIG. 6 is an illustrative view of the Alerts screen of the present disclosure. The system may send alerts relating to blood glucose readings and other medical test data as desired. An alert message may be sent to a designated person and email address as stored in the device and system. The alert may be sent via email or as an SMS message. The user may designate whether the blood glucose reading, or score falls into one of the following categories of warnings: Warning Low, Warning High, Emergency Low, Emergency High so as to indicate to the recipient whether the user's blood glucose reading is a level to initiate action or diagnosis by a medical or health care provider such as a nurse or treating physician. The user may designate the frequency of the alert and designate the number of times the message is to be sent or expected to be sent in a given day or time period. A threshold limit may be designated such that an alert message is sent to the designated recipient if under this threshold amount. The alert can be sent for one or more patients or users and each patient or user can designate as many recipients as they choose as well as the frequency of alter messages to be sent.

FIG. 7 is an illustrative view of the Registration screen of the present disclosure. Upon using the device and corresponding system, a user registers their device with the corresponding systems software. This includes the user's personal and medical information as well as their corresponding mobile and stationary devices. A user's mobile device's International Mobile Station Equipment Identity is recorded a unique identification number for GSM mobile phones. Multiple devices per user can be registered which enables all of a specified user's devices to communicate wireless with one another. Devices can be updated and removed as necessary.

A Summary is below on the use of the apparatus and method of the present disclosure and how each of patients, healthcare providers, and insurance/financially interested parties can use and utilize the present disclosure. The system automatically sends glucose readings via text message, email or fax to family members, caregivers, physicians or other designees. For examples, if you require your blood glucose results to be released and transmitted two times a day to your doctor but three times a day to your nurse practitioner then the system allows for that. The system allows for multiple periods of sending to multiple designated users. The frequency of transmitting results can be adjusted depending on the user, healthcare provider and patient's needs. All data is stored on a website that can be accessed by the patient and whomever patient designates as an authorized user.

Data is collected and may be used for Medicare Part B Audits. The system of the present disclosure is compatible and compliant with “HL7,” or Health Level 7, a format for exchanging patient health information to create patient registries. Health Level-7 or HL7 refers to a set of international standards for transfer of clinical and administrative data between software applications used by various healthcare providers. Data is collected and may be integrated into various online patient portals or other electronic medical record systems. Data can be pulled from the present disclosures system and device and transmitted or pushed by the system to multiple Medical Data Platforms via an open application interface (API).

The system of the present disclosure provides Greater control and understanding of a patient's diabetes. The system of the present disclosure automatically maintains logbooks and graphical/trend reports. The system of the present disclosure provides real time results which leads to better glycemic control. The system of the present disclosure enables automated diabetic supply reorder reminders. The system of the present disclosure automatically creates electronic patient data required to comply with Medicaid/Medicare Part B Utilization Guidelines and justifies and documents reason for frequent prescribed diabetes testing. For healthcare providers, the system of the present disclosure, ensures compliance and accuracy with patient glucose readings, improves care coordination and collaboration with no additional costs, allows for automatic and electronic record keeping eases case management; and provides detailed usage records for regulatory and reimbursement requirements. For insurers, the system of the present disclosure, potentially saves billions of dollars in healthcare costs stemming from improved patient care and fraud prevention, complements existing diabetes management programs, and provides efficient data management. Through the system's communication network, blood glucose readings are recorded in a central database which in turn communicates back to the device/apparatus of the disclosure with confirmation of receipt of the readings.

The device or apparatus of the disclosure includes a glucometer with unique added functionality to transmit the glucose readings. The device may use various transmission protocol means such as USSD message transmission technology, SMS technology or GPRS technology. Through these transmission protocols, messages and data are transmitted to a central database where the messages and data are stored. These multiple ways of communication ensure that no message or data record to and from the device is lost. Each system of communication acts as a backup for the other and is programmed to work if one system fails. Once readings and results are stored, a text message (via SMS) can be sent to pre-defined recipients and a corresponding web site application can display the information, run reports, issue alerts, create graphs and more.

This disclosure describes the communication functionality and the record layout to transmit the glucose reading information. The system and device automatically uploads your glucose readings. Such readings may be directed to a plurality of individuals as programmed by the user. The device of the present disclosure has the functionality of an accurate glucose reading device (including, but not limited to a configuration by which calibration for precision and accuracy is established and maintained), processes the reading correctly within the device, and prepares a record for transmission according to the impetus of the disclosure as described herein. The device's capabilities are critical to successful operation of device transmission and are described in details in the “device architecture and specifications” document and as described in U.S. Patent Provisional Application No. 62/169,875 filed Jun. 2, 2015.

If there is no network coverage in the area, the device is constructed and configured to store the information within the device and transmit the information the next time a reading is taken. In one embodiment, the device stores up to 100 unsent readings and be able to send them at later time. The device captures the local date and time from a global network, using a GSM module, and submits the date and time as part of the record layout. The device keeps the last reading successfully sent and sends it again on the next transmission. This redundancy is to ensure no readings are missed. A central database checks and ensures that redundant records are not inserted into the database, by comparing new records to existing records already stored. The speed of the transmission depends on the local network in each location where the readings are taken. Each device has a GSM module incorporated therein. The device of the present disclosure includes a subscriber identity module or subscriber identification module (SIM) card. A SIM card is an integrated circuit that is intended to securely store the international mobile subscriber identity (IMSI) and the related key used to identify and authenticate subscribers on mobile telephony devices (such as mobile phones and computers). The SIM card of the device may be a physical SIM card or virtual SIM (a mobile phone number provided by a mobile network operator that does not require a physical SIM card to connect phone calls to a user's mobile phone) and is attached to a GSM module and communicates with the local networks. Once readings are sent from the device to the GSM module, the reading, or readings are transmitted to the network using the SIM card. The transmission is done by formatting a message with various lengths of 1 and up to 80 characters. The 80 characters limitation is to ensure that every network in the world can support the transmission. Each message must end with a special character that indicates end of transmission. Each record can carry up to four readings. Up to three of the readings are new and the fourth one is always a redundant reading of the last successful reading. See record layout below for further illustration. In another embodiment each record may contain additional records. However, to ensure redundancy, one of the records will always be redundant while the remaining are new. In another embodiment, the device has a SIM card with 3 IMSIs.

Each device is constructed and configured with an indication pointer. The indication pointer will always point to the memory address of the last reading that was already sent successfully with a positive confirmation of receipt from the central database. In normal operation after a glucose measurement is recorded, both the new reading and the last reading will be sent immediately after the measurement. Subsequently, the pointer will be updated and point to the new memory address. In this case, two readings are sent via one message. The last reading is for a redundant verification and synchronization and should not be inserted into the central database. Redundant messages are automatically sent by the system.

If the transmissions failed for any reason, the unsent reading(s) are kept within the device and are configured to store a plurality of unsent readings. In one embodiment, the device is configured to keep up to 100 unsent readings. Once the connectivity is restored and upon a new measurement or reading, the unsent reading(s) will be sent. The transmission of unsent readings can be manual, automatic, or combinations thereof. The device is capable of storing records for a single user or for multiple user as would be common in a hospital or long term care facility setting.

If one to three readings were not sent, then the unsent reading(s) are sent together with the last reading already sent successfully before and stored in central database, for a total of maximum four readings in one message. After the message is sent and confirmed successfully, the pointer will be updated and point to the new last reading. The new last reading will become the last reading in next message. If more than three readings were not sent, the device will automatically repeat the process above and send several messages, until all readings are sent. The device will ensure that each message always has one redundant reading for synchronization.

The central database, upon successful completion of processing the incoming record, will reply with the message “success”. The device, upon receiving this message, will display “OK” on the user screen, and will update the pointers as described above. The above message solution and redundancy process may use USSD messages as form of communication as well as GPRS, Short Text Message (SMS) method and Voice channels.

The record layout and the communication processes involved with sending glucose readings from a glucometer medical device according to the present disclosure, in one embodiment, is described herein below. For example, each record to be sent via a USSD message may contain up to 80 characters. The first 8 characters appear only on the first reading, while the rest of the readings in the record have only specific reading data. A color-coded record structure is as follows. Each color displays the unique characteristics of the field, and the table below gives additional information on each field. In this example you can see a record with 2 readings, separated by comma (This example is illustrative only and does not limit the scope of actual devices and methods of the present disclosure).

### Example 1

### U012345611012818341529900, 11012818401589900 #

| start | end | example | range | Description |
|---|---|---|---|---|
| 1 | 1 | u | 0~9, A~Z | Protocol Identification (U = USSD) |
| 2 | 2 | 0 | 0~9, A~Z | Customer Database Identification (if not used, set this |
| | | | | character to zero) |
| 3 | 8 | 123456 | 000000~999999 | Device Identification (In future, this can be removed, and |
| | | | | then use subscriber ID instead) |
| 9 | 10 | 11 | 10~99 | Year (2010~2099) |
| 11 | 12 | 01 | 01~12 | Month |
| 13 | 14 | 28 | 01~31 | Day |
| 15 | 16 | 18 | 00~23 | Hour (24 hours format) |
| 17 | 18 | 34 | 00~59 | Minutes |
| 19 | 21 | 152 | 000~999 | Sugar level |
| 22 | 23 | 99 | 00~99 | Battery strength in percentage (100% = 99%) |
| 24 | 24 | 0 | 0~9, A~Z | Event: Before Meal (0), After Meal (1), Control Solution Test |
| | | | | (2), After Exercise (3), After Taking Medicine (4) . . . |
| 25 | 25 | 0 | | Future Use |
| 26 | 26 | , or # | , or # | Comma(,) to separate between records, pound sign(#) on the |
| | | | | last record |

### Length of Each Record:

| Header | Read 1 | Read 2 | Read 3 | Read 4 |
|---|---|---|---|---|
| 1 | | | | |
| 1 | | | | |
| 6 | | | | |
| | 2 | 2 | 2 | 2 |
| | 2 | 2 | 2 | 2 |
| | 2 | 2 | 2 | 2 |
| | 2 | 2 | 2 | 2 |
| | 2 | 2 | 2 | 2 |
| | 3 | 3 | 3 | 3 |
| | 2 | 2 | 2 | 2 |
| | 1 | 1 | 1 | 1 |
| | 1 | 1 | 1 | 1 |
| | 1 | 1 | 1 | 1 |
| 8 | 18 | 18 | 18 | 18 |

The communication between the device, server, and the web site central data base is done using XML commands. The device sends a message. The HLR changes it to XML command and transfers it to the server. The server sends the XML to the IP address of the web site. The web site processes the request and generates a reply to XML back to server. The server sends the XML to the HLR. The HLR changes the XML to USSD message and sends it to the device. The device displays the message on the screen as “OK” if it gets “success” or “ERR” if the return message is different.

### Examples

### Message Sent to Web Site:

<mo-ussd-submit-request version,”1.0” id=”791”>
<msisdn>19038904313</msisdn>
<userdata>U0000800110824070213470000000,
110829160077777000000#</user-data>
<imsi>310630803000351</imsi>
</mo-us sd- submit-request>

On successful processing, the web site will return to the server:
<user-data>successx</user-data>

On failure processing, the web site will return to the server:
<user-data>Invalid argument supplied</user-data>

### Server Return to Device:

<user-data>successx</user-data> or <user-data>Invalid argument supplied</user-data>

In other embodiments of the present disclosure, the Glucometer is configured with 2 way communication to send and receive USSD messages up to 140 characters long. USSD transmission is preferred for significant transmission advantages. In another embodiment, the disclosure contemplates using only 80 characters to comply with any network in the world. USSD is additionally preferred as messages are highly secured. However, the above example also works with GPRS and SMS method of message transmission.

Currently, as configured the device is functional with worldwide service in 200 countries and 600 2G networks. The device will also be configured for 4G and 3G wireless networks. The device is configured with automatic synchronization of local date/time. The device is configured with an automatic switch to adjust the device to “airplane mode” or sleep mode after sending messages or results in order to conserve the device's battery life. The device has manual ability to set different date formats and time formats. The time on the device may be set manually. Time may be synchronized on the device as well. The device may automatically change time zones based on where the user is located. The device's test strip turns the devices GSM capabilities on and off. The device is comprised of a full color 2.4″ screen and is configured with an automatic screen shutdown to conserve energy. In another embodiment the device may be comprise a larger or smaller screen.

In one embodiment of the device, there are three test modes: before meal, after meal and control solution test. Blood glucose readings may be displayed either in mg/dl or millimole per liter (mmol/l). The unit has a single user mode and a multi-user mode whereby the multi-user supports up to 35 unique users or patients. The device may support multiple patient records in the same unit wherein all records may be stored on the device's SIM card or in the cloud storage system of the user or health care provider or where directed. The unit stores the last 1,000 reading records per patient/user up to a total of up to 35,000 records. The unit currently supports 6 built-in languages and is configurable to manufacture specification supporting up to 80 different languages with an automatic switch to local language of selected languages. The device currently supports the following languages: English, Arabic, Hebrew, Spanish, French, Hungarian, Chinese, Italian and Turkish. The device has a display for 7 digits for the device ID's, IMEI, IMSI and SIM tool kit. In another embodiment, the device may store a plurality of devices per patient/user. The device is configurable to select networks manually and for automatic network selection to be always on. The device may send mock alerts and tests in order to confirm proper transmission and is configurable to warn if errors in transmission occur. The device conducts a quick blood test in between about 0.5 to about 5 seconds. The device conducts a quick communication to indicate a successful recording of a user's blood glucose, up to 20 seconds to get a reply “Successfully Recorded.”

For marketing purposes, the device is selectively configurable to display any one or combination of a customer specific logo, various advertising messages on screen, and the like. The device may contain an advertising module where product placement and advertisements may be featured while a glucose reading is being recorded or transmitted. The device is able to accommodate instant, directed and consumer personal advertisements. The system and device is marketed as the iGlucose® system and consists of the iGlucose® device (a glucometer) and an online diabetes management portal. iGlucose® uses machine-to-machine (M2M) cellular technology to facilitate wireless communication from areas with limited connectivity and ensures you and your diabetes care team stay connected at all times. Blood glucose readings from your iGlucose device are transmitted to a secure online database where you can access the data and share it in various graphic and tabular formats with pre-determined family members, caregivers, or healthcare professionals via email, text message, fax or by access to the web portal.

In one preferred embodiment, there is no action needed to transmit the data, i.e. no buttons to push, and a patient does not even have to remove the strip. The unit goes from blood test to data transmit automatically. In another embodiment of the present disclosure, the system and device may be interoperable with a variety of diabetic machines and devices such as insulin pumps, insulin pens, blood glucose software; diagnostic and medical devices for reading physical and bodily characteristics such as temperature via thermometers, blood pressure; and weight via scales.

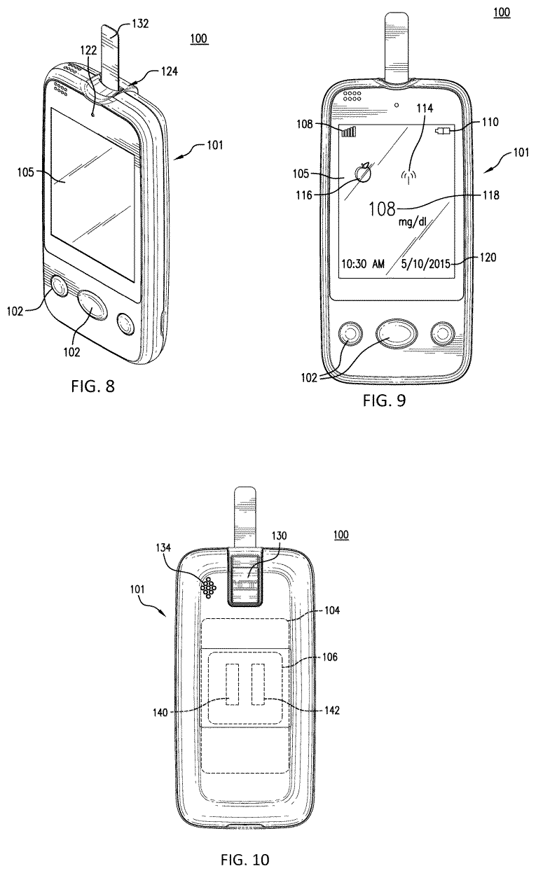

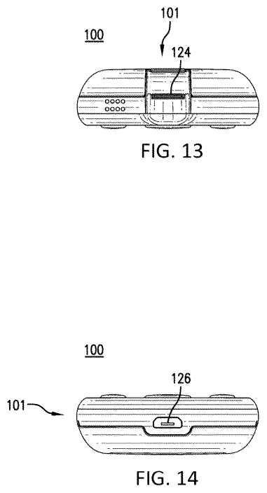

Referring now to FIGS. 8-14, there is an apparatus 100 shown in a number of views. The apparatus 100 is shown from a perspective view, front view, back view, left side view, right side view, top view, and a bottom view, respectively.

The apparatus 100 generally has an external housing 101, at least one touch sensitive button 102, a display 105, a charging indicator or light 122, a receptacle 124, a charging port 126, a sound emitting device 128, and a slidable member 130.

The display 105 is a visual display that may interface with the sound emitting device 128, such as a speaker(s), to create an audiovisual experience for the user. Preferably, the display 105 is a liquid crystal display (LCD), however, other displays including those containing light emitting diodes and organic light emitting diodes which may be enhanced with quantum dot technology. In some embodiments, it is preferable that the display 105 be touch sensitive. In yet other embodiments, the touch sensitive buttons 102 are used to navigate the menu trees and generally operate the device as a whole. In other embodiments, a combination of touch sensitive screens and buttons may be implemented.

The display 105 further has outputs, as shown in FIG. 9, corresponding to various functionality such as a signal strength indicator 108, battery meter 110, standby mode indicator 112, a sending signal indicator 114, a mode indicator 116, a test output value 118, and the date and time 120 of the location of the apparatus. As described above, the touch sensitive buttons 102 can be used to interact with or change any part of the display 105.

The signal strength indicator 108 gives a user a visual representation of the afforded strength of a cellular communications signal such as a global system for mobile communications (GSM). The signal strength indicator 108 may be represented by a varying number of bars or lines based on the strength of the signal received by the apparatus 100. This connection enables the automatic transmission of the medical test results upon completion of at least one medical test. If there is no network coverage in the area, the apparatus 100 is constructed and configured to store the information within the apparatus 100 via the memory 140 contained therein. The information can then be automatically transmitted the next time a reading is taken, or coverage becomes available. In one embodiment, the apparatus 100 stores up to 100 unsent readings to be sent at a later time. When the information is sent, the apparatus 100 also sends a time stamp (including the date) for record keeping purposes.

In some embodiments, each apparatus 100 has a GSM module incorporated therein. A SIM card, either physical SIM or virtual SIM, is attached to a GSM module and communicates with the local network. Once readings are sent from the device to the GSM module, the reading, or readings are transmitted to the network using the SIM card.

The battery meter 110 provides a visual cue as to the remaining battery level. Once a certain threshold has been passed an alert may be generated and battery meter 110 may change color. The battery may be recharged using a recharging apparatus which can be coupled to the charging port 126 located on the bottom of the apparatus 100. When the battery is recharging, a charging light 122 may appear. Once the charging has completed, this charging light 122 may change color or no longer appear.

A sending signal indicator 114 signifies that a signal has been sent from an apparatus 100 to a remote location upon the completion of a medical test. The mode indicator 116 indicates the operational mode of the apparatus 100 which may correspond to the type of test to be performed or the timing of the test to be performed. The test output value 118 is a visual indication of a result of at least one medical test performed with the apparatus 100. The date and time 120 simply show the user the date and time of their location to ensure they remain on schedule for testing purposes as well as time stamping test results.

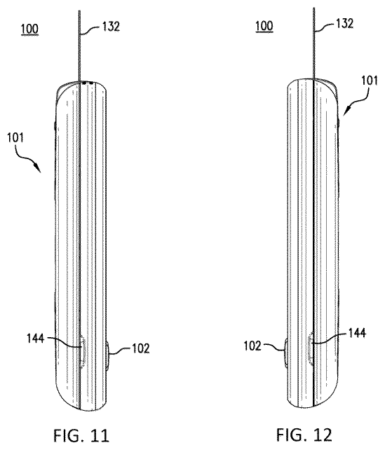

The external housing 101 is preferably comprised of at least an upper half and a lower half with the upper half being coupled to the lower half defining a space therebetween. The upper half may be separable from the lower half via tabs 144 as shown in FIGS. 11-12. This space defined by the external housing 101 houses at least the power source or battery 104, processor 106, and memory 140. The processor 106 contains instructions thereon for executing at least one program directed towards medical testing and its applications. Further, once the medical test has been completed, the results are stored in the memory 140 and automatically sent to a remote location, such as a server or doctor's office or the like, via a wireless transceiver 142. The medical test results may be sent via SMS, email, fax, and the like or some combination thereof.

The external housing 101 provides for a receptacle 124 and a charging port 126. The charging port 126, as described above, enables a charging apparatus to be employed to recharge the power source or battery 104 of the apparatus 100.

The receptacle 124 enables a medical testing apparatus 132 to be inserted therein. The medical testing apparatus 132 takes many forms and in some instances may be a strip for testing blood glucose levels. Such a strip is generally known in the art and contains a first end having an electrical connector capable of establishing an operable electronic connection with the apparatus 100. The opposing end of the strip may have an area to receive a bodily fluid such as blood. The bodily fluid causes a reaction in the strip which is measured by the apparatus 100. In other embodiments, other types of testing may be employed. Further, the medical testing apparatus 132 may also take other forms. Once the medical test has been completed, the slidable member 130 is used to eject the medical testing apparatus 132.

At least one embodiment of the present disclosure and its technical specifications and associated hardware are described in the table below.

TABLE 1

| | | |
|---|---|---|
| Main | Sub | Details |

Hardware

| GSM | GSM Platform | | MT6260 |
|---|---|---|---|
| | Mode | | GSM + GPRS + USSD |
| | Frequency | | GSM 850/900/1800/1900 |
| | Antenna | | Interior on the bottom |
| Glucose | Type | | Module mounted |
| | IC | | NEC 78F0593 |
| | Test Sample | | Fresh capillary whole blood |
| | Test Result | | Plasma/Serum glucose |
| | Sample Size | | Less than 0.5 μL |
| | Measuring Time | | Less than 5 seconds |
| | Measuring Range | | 20-600 mg/dL (1.1-33.3 mmol/L) |
| | Hematocrit Range | | 30%-55% |
| | Operating Temp. | | 10° C.-40° C. (50° F.-104° F.) |
| | Range | | |
| | Operating Relative | | 10%-90% RH |
| | Humidity | | |
| | Storage/Transport | | 0° C.-50° C. (32° F.-122° F.) |
| | Temp. Range | | |
| | Storage/Transport | | 10%-90% RH |
| | Relative Humidity | | |
| | Atmospheric | 700-1060 hPa | |
| | pressure | | |
| General | LCM | Size | 2.4″QVGA |
| | | Nature | Hi contrast TFT |
| | | Colors | 260K |
| | | Resolution | 320 * 240 pixels |
| | Button pad (3 | Left | Menu, information menu |
| | Buttons) | button | |
| | | Middle | ON/OFF; Enter, test mode change |
| | | button | |
| | | Right | Averages, readings history |
| | | button | |
| | Dimension | 100 * 50 * 15 mm | |
| | Port | Micro- | Charging, software download |
| | | USB | |
| | Speaker | 15 mm | mini-speaker as buzzer or vocal reminding |
| | Battery | Capacity | 3.7 V, 1,000 mAh Li-Ion |
| | | Last | 25-30 days for normal use (2-3 tests per day) |
| | | time | |
| Accessory | Wall Charger | Adapter | Shenzhen Samson Power |
| | | | Technology |
| | | | Model: S050-050-US |
| | | | AC input: 100-240 VAC, 50/60 Hz, 0.2 A; |
| | | | DC output: 5 V, 0.5 A |
| | | USB | Micro SP, 100 cm |
| | | cable | |

Software functions

| Data entry | Storage | 1,000 entries per user, up to 35 users |
|---|---|---|
| Main standby | GSM signal strength, battery level, carrier name, | |
| page | date/time etc. | |
| Message | Yes | Server can send to SGM-03, for any tips, |
| | | feedbacks etc. |
| Alarm | Yes | 5 items |
| GPRS/USSD | Yes | GPRS Class l.2 |

| | |
|---|---|
| Languages | English, French, Spanish, Hungarian, Arabic, Hebrew and |
| | Chinese by default. |

In order to use an embodiment of the apparatus described herein or others thereof, a user preferably completes a series of steps, of which not all will be required nor are the steps necessarily required to be completed in the manner/order as described.

A user first needs to create a user account to be associated with the particular apparatus. Such an account may be created with a web/mobile application or website or other electronic programming option. Once an account has been created and, in some instances, user verified, a user can then modify their account and user profile as necessary including adding, editing, and deleting information. In order to properly associate with the apparatus in question, if a user receives a new apparatus, then they must update their profile with the specific apparatus information such as serial number and other unique apparatus identifiers. From their account and profile, a user can also set alerts to be directed in the event of an abnormal or other reading that may comprise the user's health, add or change apparatus associated the with account, and perform various other functions associated with the apparatus.

In order to complete a medical test, such as a glucose blood test, a user may follow the following steps. First, a user should wash their hands in warm water using soap and rinse and dry completely.

Second, the user should select the appropriate test mode: “Before Meal” or “After Meal.” This can be done either by using the touch sensitive buttons. An icon will be displayed on the display to indicate the selection made: “Before Meal” shows, for example, a whole apple icon, “After Meal” shows, for example, a partially eaten apple icon. If the test is performed within about two hours after a meal, use the “After Meal” setting, otherwise, the user would typically use the “Before Meal” setting.

Third, a user should remove a new test strip from a vial and replace the vial cap tightly after removing the test strip.

Fourth, the user should use a safety lancet or lancing device to prick at least one finger and draw a drop of blood.

Fifth, the test strip should be inserted, usually with the arrow side facing up, into the strip slot of the device. A message such as “Strip Inserted” and then “Apply a Drop of Blood” may appear on the display. The user should check that the code number on the meter matches the code on the vial. If the two numbers match, the user may begin blood testing. Otherwise, the user should insert a new strip.

Sixth, hold the device and apply a drop of blood to the top front of the test strip, where several stripes are visible. The test result will show in about five seconds and a “Glucose Value” number, or test results, appears on the display. After a few more seconds, the sending signal icon blinks on the display as the test result is transmitted to the online database, remote location, doctor, etc. A message such as “Successfully Recorded” may subsequently appear on the display. This transmission occurs automatically and requires no undue input or steps from the user.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present disclosure may be connected to and/or communicate with entities such as, but not limited to: one or more users from user input devices; peripheral devices; an optional cryptographic processor device; and/or a communications network. For example, the present disclosure may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present disclosure may be based on computer systems that may comprise, but are not limited to, components such as: a computer systemization connected to memory.

### Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother) board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present disclosure to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply to communications beyond the instant computer systemization to communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present disclosure and beyond through various interfaces. Should processing requirements dictate a greater amount speed and/or capacity, distributed processors (e.g., Distributed embodiments of the present disclosure), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present disclosure may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present disclosure may be implemented via the microprocessor and/or via embedded components; e.g., via ASIC, coprocessor, DSP, FPGA, and/or the like. Alternately, some implementations of the present disclosure may be implemented with embedded components that are configured and used to achieve a variety of features or signal processing.

Depending on the particular implementation, the embedded components may include software solutions, hardware solutions, and/or some combination of both hardware/software solutions. For example, features of the present disclosure discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present disclosure. A hierarchy of programmable interconnects allow logic blocks to be interconnected as needed by the system designer/administrator of the present disclosure, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present disclosure may be developed on regular FPGAs and then migrated into a fixed version that more resembles ASIC implementations. Alternate or coordinating implementations may migrate features of the controller of the present disclosure to a final ASIC instead of or in addition to FPGAs. Depending on the implementation all of the aforementioned embedded components and microprocessors may be considered the “CPU” and/or “processor” for the present disclosure.

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present disclosure thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface bus(ses) may accept, connect, and/or communicate to a number of interface adapters, conventionally although not necessarily in the form of adapter cards, such as but not limited to input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E) IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present disclosure is accessible through remote clients (e.g., computers with web browsers) by users. Network interfaces may employ connection protocols such as, but not limited to direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present disclosure), architectures may similarly be employed to pool, load balance, and/or otherwise increase the communicative bandwidth required by the controller of the present disclosure. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include card readers, dongles, fingerprint readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices, such as other components of the cooling chest system, including temperature sensors, ice dispensers (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present disclosure. Peripheral devices may also include, for example, an antenna, audio devices (e.g., line-in, line-out, microphone input, speakers, etc.), cameras (e.g., still, video, webcam, etc.), drive motors, ice maker, lighting, video monitors and/or the like.

Cryptographic units such as, but not limited to, microcontrollers, processors, interfaces, and/or devices may be attached, and/or communicate with the controller of the present disclosure. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present disclosure and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course, such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

The operating system component is an executable program component facilitating the operation of the controller of the present disclosure. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present disclosure to communicate with other entities through a communications network. Various communication protocols may be used by the controller of the present disclosure as a subcarrier transport mechanism for interaction, such as, but not limited to multicast, TCP/IP, UDP, unicast, and/or the like.

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI)(Objective-) C(++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers and allows for the manipulated generation of the Web pages through interaction with other program components. After a Domain Name System (DNS) resolution portion of an HTTP request is resolved to a particular information server, the information server resolves requests for information at specified locations on the controller of the present disclosure based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present disclosure, operating systems, other program components, user interfaces, Web browsers, and/or the like.

Access to the database of the present disclosure may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present disclosure. In one embodiment, the information server would provide a Web form accessible by a Web browser. Entries made into supplied fields in the Web form are tagged as having been entered into the particular fields and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present disclosure as a query. Upon generating query results from the query, the results are passed over the bridge mechanism and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D) HTML, FLASH, Java, JavaScript, etc. interface libraries such as, but not limited to, Dojo, jQuery (UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present disclosure. The combined application may be nugatory on systems employing standard Web browsers.

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C(++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present disclosure.

Access to the mail of the present disclosure may be achieved through a number of APIs offered by the individual Web server components and/or the operating system.

Also, a mail server may contain, communicate, generate, obtain, and/or provide program component, system, user, and/or data communications, requests, information, and/or responses.

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present disclosure may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the component of the present disclosure to engage in secure transactions if so desired. The cryptographic component facilitates the secure accessing of resources on the present disclosure and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The database component of the present disclosure may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present disclosure may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present disclosure is implemented as a data-structure, the use of the database of the present disclosure may be integrated into another component such as the component of the present disclosure. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to user_id, client_id, client_ip, client_type, client_model, operating_system, os_version, app_installed_flag, and/or the like. An Apps table may include fields such as, but not limited to app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number of beverages, current_beverage_temperature, current_ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present disclosure. Also, various accounts may require custom database tables depending upon the environments and the types of clients the system of the present disclosure may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present disclosure may be configured to keep track of various settings, inputs, and parameters via database controllers.

Specifically, in an embodiment, the apparatus 100 may be further comprised of at least one of an external data processing unit (not depicted) and a cellular modem (not depicted), wherein said modem is able to communicate and/or transmit at least one of initial blood glucose data 1502 and encrypted blood glucose data 1506 to one or more client devices (e.g., a cell phone, laptop, personal computer, tablet, etc.). It should be appreciated that, as described herein, the cellular modem is a device that adds cellular connectivity to devices such as, laptops, desktop computers, tablets, etc. Furthermore, it should be appreciated that the cellular modem may replace existing BLE modules in Bluetooth enabled devices as described herein.

In a further embodiment, the cellular modem may be embedded within the external data processing unit and/or a standalone device connected to the external data processing unit. The connection between the external data processing unit and the cellular modem may be achieved via, a USB connection. As a nonlimiting example, the cellular modem may be selected from the group consisting of AT&T Momentum, Verizon 551 L, USB cellular modems, and motherboard mounted cellular chipsets manufactured by Novatel Wireless, Sierra Wireless, Huawei, and the like. In a further nonlimiting example, the cellular modem may operate by switching between cellular and satellite communications.

Furthermore, the cellular modem may be configured to automatically connect to a slower network when the faster network is not available. The cellular modem may also monitor the reliability of all available connections. The reliability of a network (e.g., the wireless network 1516) may be determined from information collected by the cellular modem, which includes, but is not limited to, signal strength, quality, availability, packet loss, retransmits, packet latency, throughput speed, and other cell tower signaling quality factors. The cellular modem may then compare the aforementioned information to a reliability threshold for determining whether to maintain or terminate a connection to the network. The reliability threshold is often automatically set by a cellular carrier or may be manually set by the user of the external data processing unit.

Further, it should be appreciated that the cellular modem is also configured to establish a connection with cellular networks in which the cellular modem is located. The cellular modem may be configured to monitor and detect all cellular networks, comprising the wireless network 1516, as the cellular modem moves from one network coverage area to another network coverage area. The cellular modem may detect when a connection to the wireless network 1516 is made. For example, the cellular modem may detect whether the wireless network 1516 is a 3G, 4G, or 5G network, as well as which cellular network provider (e.g., AT&T, T-Mobile, Verizon, etc.) the modem has connected to.

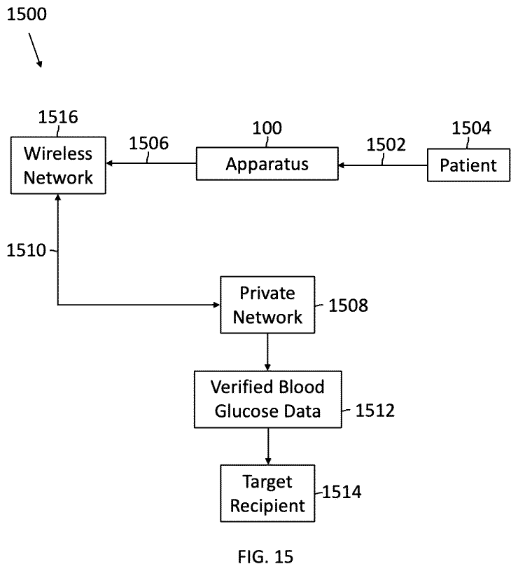

Referring to FIG. 15, the systems and methods of layering security for cellular-enabled blood glucose data transmission (the “system”) 1500 may include the apparatus 100.

In an embodiment, the apparatus 100 collects initial blood glucose data 1502 from the patient 1504. As a nonlimiting example, the apparatus 100 may include devices, such as, but not limited to, a blood glucose monitor. Further, the apparatus 100 may utilize various transmission protocol means, such as, but not limited to USSD message transmission technology, CMDA, SMS, GSM, and/or GPRS technology. Through said transmission protocols, at least one of the messages and the initial blood glucose data 1502 may be transmitted to a central database where said messages and data 1502 are stored.

Upon collection of the initial blood glucose data 1502, the apparatus 100 may encrypt said data 1502, thus transforming the initial blood glucose data 1502 into encrypted blood glucose data 1506. In an embodiment, the apparatus 100 may encrypt the initial blood glucose data 1502 with a shared secret.

In one embodiment, the shared secret may consist of a specific piece of data, such as a Personal Identification Number (PIN) or password. The shared secret may enable two or more parties to securely exchange information. Specifically, after encrypted information is exchanged, the shared secret may enable the parties to decrypt the information, ensuring that only those with access to the shared secret can access the content.

In an embodiment, the shared secret may be shared prior to transmission of the encrypted blood glucose data 1506 and/or created at the start of transmission of the encrypted blood glucose data 1506. In a nonlimiting example, if the shared secret is shared prior to the transmission, the shared secret may be referred to as a pre-shared key. As a further nonlimiting example, the shared secret, may be created at the start of the transmission with a key-agreement protocol. In yet a further nonlimiting example, the shared secret may be at least one of an asymmetric-key algorithm and a symmetric-key algorithm.

In an embodiment, the symmetric-key algorithm may utilize a key to convert the raw patient data into the encrypted blood glucose data 1506. In a nonlimiting example, the symmetric-key algorithm may be comprised of at least one of a key and a symmetric block cipher. In a further embodiment, the key may be at least one of a 128-bit key, a 256-bit key, a 576-bit key, and a 2040-bit key. However, any suitable size bit key alternative may comprise the key. In yet another embodiment, the symmetric block cipher may be comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher. However, any suitable symmetric block cipher alternative may be utilized.

Additionally, upon creation of the encrypted blood glucose data 1506, the apparatus 100 may sign said data 1506 via a signing algorithm, thus creating a data signature. For example, the encrypted blood glucose data 1506 may be cryptographically signed. The encrypted blood glucose data 1506 may be signed via a signing algorithm, which may include at least one of Rivest-Shamir-Adleman (RSA) algorithms, EIGamal signature scheme, Digital Signing Algorithm (DSA), and Elliptical Curve Digital Signature Algorithm (ECDSA). For example, the signing algorithm generates a first hash to accompany the encrypted blood glucose data 1506.

Further, the apparatus 100 may connect to the wireless network 1516. In an embodiment, the apparatus 100 may connect to the wireless network 1516 via the external data processing unit. For example, the cellular modem, embedded within the external data processing unit, may connect to the wireless network 1516. In another example, the cellular modem may connect to the external data processing unit via a USB cable. Such a connection to the wireless network 1516 may be achieved via an Access Point Name (APN). As a nonlimiting example, the APN may be a private APN. In an additional embodiment, the APN may require the client devices and/or the apparatus 100 to be authorized prior to accessing the wireless network 1516. The authorization may register the client devices and/or the apparatus 100 via a computing device identifier. The computing device identifier may be at least one of a Subscriber Identification Module (SIM), an International Mobile Equipment Identity (IMEI), and an Integrated Circuit Card Identification Number (IICID).

After the apparatus 100 connects to the wireless network 1516, the encrypted blood glucose data 1506 may be transmitted. For example, the encrypted blood glucose data 1506 may be transmitted to a private network 1508. In an embodiment, the encrypted blood glucose data 1506 may be transmitted from the wireless network 1516 to the private network 1508 via a tunnel 1510. For example, the tunnel 1510 may connect the wireless network 1516 to the private network 1508, such that the encrypted blood glucose data 1506 may travel from the wireless network 1516 to the private network 1508, or vice versa. As a nonlimiting example, the tunnel 1510 may be a persistent and fully redundant Internet Protocol Security (IPsec) Virtual Private Network (VPN) tunnel. Moreover, the tunnel 1510 may leverage the symmetric-key algorithm to encrypt and protect the encrypted blood glucose data 1506 while traveling through the tunnel 1510. In another embodiment, the tunnel 1510 may also utilize Transport Layer Security (TLS) as another form of protection for transmitting the encrypted blood glucose data 1506 through the tunnel 1510.

Further, once the encrypted blood glucose data 1506 has travelled through the tunnel 1510, said data 1506 may be received by the private network 1508. In an embodiment, the system 1500 may generate an acknowledgment that is subsequently sent to the apparatus 100 upon acceptance of the encrypted blood glucose data 1506 by the private network 1508.

Upon receipt of the encrypted blood glucose data 1506, the private network 1508 may verify the data signature of said measurements 1506. For example, the private network 1508 may compute a second hash at ingest of the encrypted blood glucose data 1506. Moreover, the second hash may be compared with the first hash. If said first and second hash are a match, then the private network 1508 may accept the encrypted blood glucose data 1506, thus verifying the authenticity of said measurements 1506. If the first and second hash are not a match the private network 1508 may reject the encrypted blood glucose data 1506, thus ensuring the data 1506 comes from a verified source.

Additionally, the private network 1508 may decrypt the encrypted blood glucose data 1506 after verifying the first hash and the second hash are a match, thus transforming said data 1506 into verified blood glucose data 1512. The verified blood glucose data 1512 may then be quality controlled and/or stored. Further, the verified blood glucose data 1512 may be transmitted to a target recipient 1514. In such an embodiment, the verified blood glucose data 1512 may be transmitted to one or more of the client devices of the target recipient 1514. In a further embodiment, the target recipient 1514 may be the patient 1504 whom the verified blood glucose data 1512 corresponds to. In another embodiment, the target recipient 1514 may be a healthcare provider (e.g., a physician, a nurse, etc.) for the patient 1504.

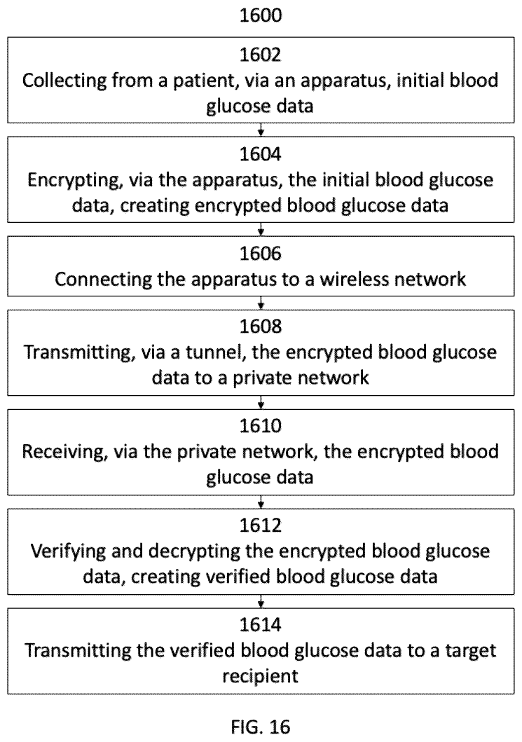

Turning to FIG. 16, a method of layering security for cellular-enabled blood glucose data transmission (the “method”) 1600 may be comprised of at least a first step 1602.

In the first step 1602, the apparatus 100 may collect the initial blood glucose data 1502 from the patient 1504.

In a second step 1604 of the method 1600, after collecting the initial blood glucose data 1502 from the patient 1504, the apparatus 100 may encrypt, and sign said initial data 1502, thus transforming it into encrypted blood glucose data 1506. In an embodiment, the apparatus 100 may encrypt the initial blood glucose data 1502 with the shared secret, wherein the shared secret may be the symmetric-key algorithm. In another embodiment, the symmetric-key algorithm may be comprised of the key and the symmetric block cipher. For example, the symmetric block cipher may be AES-256. Moreover, the encrypted blood glucose data 1506 may be signed via the signing algorithm, wherein the first hash is created.

The method 1600 may be further comprised of a third step 1606, wherein the apparatus 100 may connect to the wireless network 1516. In an embodiment, the connection may be achieved via the APN.

Additionally, a fourth step 1608 may be employed, wherein the encrypted blood glucose data 1506 is transmitted to the private network 1508 from the apparatus 100 via the tunnel 1510. In an embodiment, the encrypted blood glucose data 1506 may first be transmitted from the apparatus 100 to the wireless network 1516, and then from the wireless network 1516 to the private network 1508 via the tunnel 1510. In another embodiment, the tunnel 1510 may be a persistent and fully redundant IPsec VPN tunnel. Furthermore, the tunnel 1510 may also leverage TLS, as an additional form of protection for transmitting the encrypted blood glucose data 1506 through the tunnel 1510.

A fifth step 1610 of the method 1600 may entail the private network 1508 receiving the encrypted blood glucose data 1506. In an embodiment, upon receipt of the encrypted blood glucose data 1506, the private network 1508 may transmit an acknowledgment to the apparatus 100.

Furthermore, the method 1600 may employ a sixth step 1612, wherein the private network 1508 may verify and decrypt the encrypted blood glucose data 1506. The verification and decryption of the encrypted blood glucose data 1506 may transform said data 1506 into verified blood glucose data 1512. In such a step 1612, the second hash may be generated upon receipt of the encrypted blood glucose data 1506, wherein said second hash is then compared to the first hash. Such a comparison may act as a verification of the source of encrypted blood glucose data 1506.

The method 1600 may further include a seventh step 1614, wherein the verified blood glucose data 1512 is quality controlled and/or relayed to the target recipient 1514. In an embodiment, the target recipient 1514 may be the patient 1504 whom the verified blood glucose data 1512 corresponds to and/or a healthcare provider (e.g., a physician, a nurse, etc.) for the patient 1504.

As described herein, “NFC” is a set of communication protocols for communication between two electronic devices over a distance of 4 cm or less. NFC devices can act as electronic identity documents and keycards and may be used in contactless payment systems and allow mobile payment replacing or supplementing systems such as credit cards and electronic ticket smart cards. NFC can be used for sharing small files such as contacts and bootstrapping fast connections to share larger media such as photos, videos, and other files.

In an embodiment, at least one of the system 1500 and the method 1600 may aid in the prevention of a data breach via a cyberattack. For example, layering two or more of: (1) encrypting the initial blood glucose data 1502; (2) connecting the apparatus 100 to the wireless network 1516 via the APN; (3) transmitting the encrypted blood glucose data 1506 from the wireless network 1516 to the private network 1508 via the tunnel 1510; (4) generating the acknowledgement and sending it to the apparatus 100 upon the private network's 1508 acceptance of the encrypted blood glucose data 1506; (5) verifying the data signature of the encrypted blood glucose data 1506 and decrypting said data 1506; and (6) enabling the target recipient 1514 to authenticate the sender of the verified blood glucose data 1512 may safeguard remote data transmissions of protected healthcare information from cellular-enabled devices. As a nonlimiting example, layering 1, 2, and 3 above ensures that layer 2 reinforces layer 1 and that layer 3 reinforces layer 2. The redundancy in layering security measures creates a tamper proof system for transmitting protected healthcare information. Moreover, the industry at large utilizes the public Internet to transmit information without providing origin authentication. However, both the system 1500 and method 1600 are able to guarantee the origin and authenticity of protected healthcare information by sending encrypted healthcare information through the tunnel 1510 from the wireless network 1516 to the private network 1508 and requiring a comparison and match of the first and second hashes. The aforementioned layering ensures protected healthcare information (i.e., the initial data 1502, encrypted data 1506, and verified blood glucose data 1512) reaches the target recipient 1514, while simultaneously proscribing bad actors from accessing said protected information.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A system for improving the security of cellular-enabled blood glucose data transmission by layering security, the system comprising:
an apparatus;
a wireless network connected to the apparatus;
a private network connected to the wireless network via a persistent and fully redundant Internet Protocol Security (IPsec) Virtual Private Network (VPN) tunnel;
one or more computer processors; and
a memory having stored therein machine executable instructions, that when executed by the one or more processors, cause the system to:
collect, via the apparatus, initial blood glucose data from a patient;
encrypt, via the apparatus, the initial blood glucose data with a shared secret,
wherein encrypting the initial blood glucose data creates encrypted blood glucose data;
generate, via the apparatus, a first hash using a signing algorithm;
transmit, via the persistent and fully redundant IPsec VPN tunnel, the encrypted blood glucose data from the apparatus to the private network;
generate, via the private network, a second hash;
compare, via the one or more computer processors, the first hash to the second hash;
decrypt, via the one or more computer processors, the encrypted blood glucose data upon a match of the first and second hash,
wherein decrypting the encrypted blood glucose data creates verified blood glucose data; and
transmit, via the one or more computer processors, the verified blood glucose data to a target recipient.

2. The system of claim 1, wherein the shared secret is a symmetric-key algorithm comprising:
at least one key; and
a symmetric block cipher.

3. The system of claim 2, wherein the at least one key is comprised of at least one of a 128-bit key, a 256-bit key, a 576-bit key, and a 2040-bit key.

4. The system of claim 2, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

5. The system of claim 2, wherein the persistent and fully redundant IPsec VPN tunnel leverages the symmetric-key algorithm to encrypt the encrypted blood glucose data while said encrypted blood glucose data is travelling through the persistent and fully redundant IPsec VPN tunnel.

6. The system of claim 1, wherein the apparatus connects to the wireless network via an Access Point Name (APN).

7. The system of claim 1, wherein the persistent and fully redundant IPsec VPN tunnel is further comprised of Transport Layer Security (TLS).

8. The system of claim 1, wherein the verified blood glucose data is transmitted to one or more apparatuses of the target recipient.

9. The system of claim 1, wherein the signing algorithm is comprised of at least one of Rivest-Shamir-Adleman (RSA) algorithms, EIGamal signature scheme, Digital Signing Algorithm (DSA), and Elliptical Curve Digital Signature Algorithm (ECDSA).

10. A method for improving security of cellular-enabled blood glucose data transmission by layering security, the method comprising:
collecting, via patient interaction with apparatus, raw blood glucose data from the patient;
encrypting, via an encryption algorithm generated by the apparatus, the raw blood glucose data, creating encrypted blood glucose data;
signing, via a signing algorithm, the encrypted blood glucose data creating a first hash;
connecting, via an Access Point Name (APN), the apparatus to a wireless network;
connecting, via a persistent and fully redundant Internet Protocol Security (IPsec) Virtual Private Network (VPN) tunnel, the wireless network to a private network;
transmitting, the encrypted blood glucose data from the apparatus to the private network,
wherein, upon receipt of the encrypted blood glucose data, the private network generates a second hash;
verifying, via a comparison of the first hash and second hash, the encrypted blood glucose data;
wherein upon a match of the first hash and the second hash, the private network decrypts the encrypted blood glucose data, creating verified blood glucose data; and
transmitting the verified blood glucose data to a target recipient.

11. The method of claim 10, wherein the encryption algorithm comprises a shared secret.

12. The method of claim 11, wherein the shared secret is a symmetric-key algorithm comprising:
a key; and
a symmetric block cipher.

13. The method of claim 12, wherein the key is comprised of at least one of a 128-bit key, a 256-bit key, a 576-bit key, and a 2040-bit key.

14. The method of claim 12, wherein the symmetric block cipher is comprised of at least one of an Advanced Encryption Standard (AES) block cipher, a Blowfish block cipher, a CAST-256 block cipher, a GOST block cipher, an International Data Encryption Algorithm (IDEA) block cipher, a Rivest Cipher 6 (RC-6) block cipher, a Serpent block cipher, and a Twofish block cipher.

15. The method of claim 12, wherein the persistent and fully redundant IPsec VPN tunnel leverages the symmetric-key algorithm to encrypt the encrypted blood glucose data while travelling through the persistent and fully redundant IPsec VPN tunnel.

16. The method of claim 10, wherein the persistent and fully redundant IPsec VPN tunnel is further comprised of Transport Layer Security (TLS).

17. The method of claim 10, wherein the signing algorithm is comprised of at least one of Rivest-Shamir-Adleman (RSA) algorithms, EIGamal signature scheme, Digital Signing Algorithm (DSA), and Elliptical Curve Digital Signature Algorithm (ECDSA).
